(19) United States
(12) Patent Application Publication
(10) Pub. No.: US 2004/0170541 A1
(43) Pub. Date: Sep. 2, 2004

(54) Sheathed mid-section of a catalyst housing

(76) Inventors: Thomas Flehmig, Ratingen (DE); Martin Kibben, Disnlaken (DE); Juergen Federwisch, Freudenberg (DE); Attila Behner, Schauenburg (DE); Fred Emde, Kassel (DE); Frank Neurath, Niedenstein (DE); Rudi Reintanz, Guxhagen (DE)

Correspondence Address: PROSKAUER ROSE LLP, PATENT DEPARTMENT, 1585 BROADWAY, NEW YORK, NY, 10036-8299, US

(21) Appl. No.: 10/481,911

(22) PCT Filed: Jun. 27, 2002
(86) PCT No.: PCT/EP02/07089

(30) Foreign Application Priority Data
Jun. 29, 2001 (DE) 10131466.3

(51) Int. Cl. B01D 53/34

(52) U.S. Cl. 422/180; 422/177

(57) ABSTRACT

The invention relates to a jacket-shaped middle part (1) of a catalytic converter housing, in particular for exhaust systems for internal combustion motors in motor vehicles. The jacket-shaped middle part (1) comprises a sheet metal plate, which incorporating an intermediate layer (4) made of an equalising material, is wrapped around a monolith made of ceramic material and encloses said monolith under initial radial tension, wherein the marginal regions (5, 6) of the jacket-shaped middle part (1) mutually overlap and are welded together. The sheet metal thickness in the overlapping marginal regions is reduced to such an extent, and in that the marginal regions are mutually and vertically offset in relation to the outside of the sheet metal plate, that the sheet metal thickness of the jacket-shaped middle part remains the same around the entire circumference, also in the overlapping region (2).

The invention relates to a jacket-shaped middle part of a catalytic converter housing, in particular for exhaust systems for internal combustion motors, which jacket-shaped middle part, incorporating an intermediate layer made of an equalising material, encloses a monolith which comprises a catalytically effective material under initial radial tension, wherein the marginal regions of the sheet metal plate, which has been formed to constitute the jacket-shaped middle part, mutually overlap and are firmly interconnected.

Such middle parts of catalytic converter housings for exhaust systems of internal combustion engines, in particular in motor vehicles, are known (EP 0 818 615 A2). The housing is made so that the sheet metal plate is wrapped around the ceramic monolith which is enveloped by an expanded material as an equalising material, wherein their marginal regions are made to overlap. After this, the sheet metal plate, which in this way has been formed to constitute the jacket-shaped middle part, radially, is firmly pressed onto the ceramic monolith or metal monolith by means of retainer straps so that in the state with initial radial tension the mutually overlapping marginal regions can be welded together. Subsequently, for completing the catalytic converter housing, funnel-shaped end parts are welded to both ends of the jacket-shaped middle part.

It has been shown that during the production process the ceramic monolith is subjected to very considerable loads in the area of the mutually overlapping marginal regions, which loads can lead to damage to, or destruction of, the monolith.

It is the object of the invention to create a jacket-shaped middle part of a catalytic converter housing of the type mentioned in the introduction, in which the monolith in the area of the overlapping marginal regions of the sheet metal plate is not subjected to dangerously high pressure loads.

According to the invention, this object is met by a middle part of a catalytic converter housing of the type mentioned in the introduction, in that the sheet metal thickness in the marginal areas of the jacket-shaped middle part in the area of overlap is reduced to such an extent in relation to the remaining metal plate, and in that the marginal regions of the jacket-shaped middle part are mutually and vertically offset in relation to the outside of the sheet metal plate, that the outsides or insides of the marginal regions and of the adjoining regions without reduction in sheet metal thickness are in the same respective jacket plane.

According to the invention, due to the special design of the mutually overlapping marginal regions, despite the radial pressure loads there is no local peak load of the pressure-sensitive monolith, either during production or during operation. Instead, the monolith is subjected to an even load over its entire circumference. Consequently, fewer failures occur, both during production and in operation.

According to the invention, the sum of the reduced sheet metal thicknesses of the two marginal regions is equal to the full sheet metal thickness. Preferably, the sheet metal thickness of each of the two marginal regions is reduced to half the full sheet metal thickness of the sheet metal plate.

The reduction in the sheet metal thickness in the marginal regions and the offset arrangement of the marginal regions can be realised in various ways. According to a first embodiment, the two marginal regions are offset to opposite sides. However, the marginal regions can also be designed in a kind of tongue-and-groove fit. From the point of view of production technology, the first alternative is certainly the simpler one. It can be realised by welding-on thinner marginal strips in the manner of tailored-blanks production, or by rolling the marginal regions or by mechanical removal.

In order, during production, in particular during forming and tensioning of the jacket-shaped middle part around the monolith, which due to production tolerances can have various circumferential dimensions, to avoid uniform circumferential tension without local pressure peaks due to overlapping with a step in the thickness, according to a further embodiment of the invention, on the middle part which encloses the monolith there is to be play between the edges of the marginal regions and the opposite stepped transitions between the marginal regions and the regions where the sheet metal thickness has not been reduced. This makes it possible to shift the marginal regions one on top of the other, while the thickness relationships in the overlapping region of the marginal regions remains unchanged, so that the play in an ideal case is reduced right down to zero, with the outsides and insides of the middle part then also establishing a gap-free and step-free transition in the overlapping area.

The invention further relates to a flat sheet metal plate with marginal strips which are held on opposite margins, which marginal strips are offset vertically to the outside or inside of the plate and in opposite direction and whose sheet metal thickness is reduced such that their total thickness is equal to that of the sheet metal plate and that their outsides are aligned in the plane of the outsides of the sheet metal plate, for use as the jacket-shaped middle part of a catalytic converter housing of the design described above.

Below, the invention is explained by means of a drawing which shows one embodiment. Specifically, the following are shown:

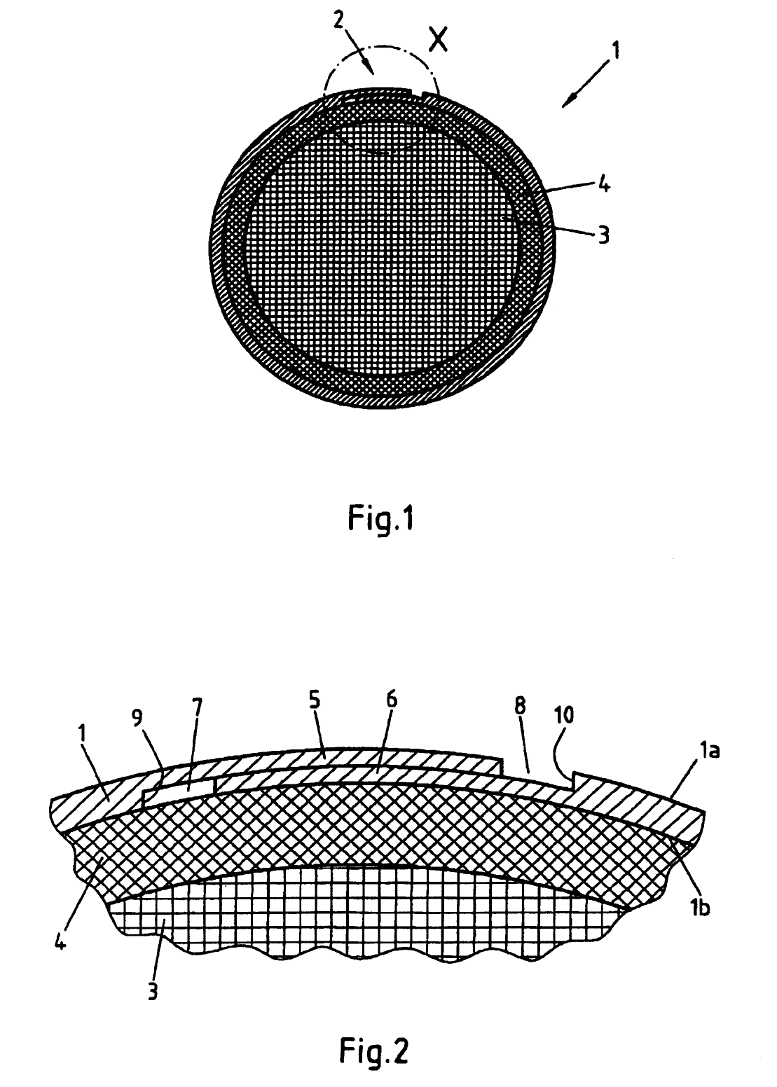

FIG. 1 a cross section of a middle part of a catalytic converter housing with enclosed ceramic monolith prior to being strapped into place with retainer straps wound around it; and

FIG. 2 an enlarged view of a section according to X in FIG. 1.

From a flat sheet metal plate, a jacket-shaped middle part 1 with an overlap region 2 is formed as an equalising material around a cylindrical monolith 3 which is made from catalytically effective material, as a rule a ceramic material, with an intermediate layer 4 made from equalising material. The equalising material holds the monolith fixed during different heat expansion of the monolith 3 and the jacket part 1. The middle part 1 comprises two marginal regions 5, 6 which extend axially, whose sheet metal thickness is half the usual sheet metal thickness of the plate. They are held on the middle part of the jacket-shaped middle part 1, which is not reduced in thickness, so as to be offset in height in relation to each other. Preferably, they are welded on by laser.

As shown above all in FIG. 2, the outside 1a of the marginal area 5 is situated in the outer jacket plane 1a of the middle part 1, while the inside of the marginal region 6 is situated in the inner jacket plane 1b of the middle part 1.

Apart from the characteristic feature, according to the invention, of a constant sheet metal thickness over the circumference of the jacket-shaped middle part 1 also in the area of overlap 2, a further characteristic feature consists of there being play 7, 8 between the edges of the mutually overlapping marginal regions 5, 6 and the stepped transitions 9, 10 which are formed by the marginal regions 5, 6 and the adjacent regions which are the thickness of the sheet metal. This play 7, 8 has been provided so that when tension is applied by means of the retainer straps which wind round the middle part 1 it is possible to shift the marginal regions 5, 6 in relation to each other, without there being any upsetting. After such tensioning, as a result of which in an ideal case the play 7, 8 is reduced to zero, the marginal areas 5, 6 can be welded together.

1. A jacket-shaped middle part (1) of a catalytic converter housing, in particular for exhaust systems for internal combustion motors, which jacket-shaped middle part (1), incorporating an intermediate layer (4) made of an equalising material, encloses a monolith (3) which comprises a catalytically effective material under initial radial tension, wherein the marginal regions (5, 6) of the sheet metal plate, which has been formed to constitute the jacket-shaped middle part (1), mutually overlap and are firmly interconnected,
characterised in that
the sheet metal thickness in the marginal areas (5, 6) of the middle part (1) in the area of overlap is reduced to such an extent in relation to the remaining metal plate, and in that the marginal regions of the jacket-shaped middle part (1) are mutually and vertically offset in relation to the outside (1a) of the sheet metal plate, that the outsides or insides of the marginal regions (5, 6) and of the adjoining regions of the middle part (1) without reduction in sheet metal thickness are in the same respective jacket plane.

2. The middle part of a catalytic converter housing according to claim 1,
characterised in that
the sheet metal thickness of the two marginal regions (5, 6) is reduced to half the full sheet metal thickness of the sheet metal plate.

3. The middle part of a catalytic converter housing according to claim 1,
characterised in that
the two marginal regions (5, 6) are offset to opposite sides.

4. The middle part of a catalytic converter housing according to claim 1,
characterised in that
the marginal regions (5, 6) are designed in the manner of a tongue-and-groove fit.

5. The middle part of a catalytic converter housing according to any one of claims 1 to 4,
characterised in that
the marginal regions (5, 6) are formed by welded-on sheet metal strips in the manner of tailored-blanks production.

6. The middle part of a catalytic converter housing according to any one of claims 1 to 5,
characterised in that
there is play (7, 8) between the edges of the marginal regions (5, 6) and the opposite stepped transitions (9, 10) between the marginal regions (5, 6) and the regions where the sheet metal thickness has not been reduced.

7. A flat sheet metal plate with marginal strips which are held on opposite margins, which marginal strips are mutually offset vertically to the outside or inside of the plate and in opposite direction and whose sheet metal thickness is reduced such that their total thickness is equal to that of the sheet metal plate and that their outsides are aligned in the plane of the outsides of the sheet metal plate, for use as the jacket-shaped middle part of a catalytic converter housing according to claim 1.

8. The sheet metal plate according to claim 7,
characterised in that
the marginal strips are welded on.
